(19) United States
(12) Patent Application Publication
(10) Pub. No.: US 2025/0184110 A1
(43) Pub. Date: Jun. 5, 2025

(54) COMMUNICATION DEVICE AND COMMUNICATION MANAGEMENT DEVICE

(71) Applicant: Fujitsu Limited, Kawasaki-shi (JP)

(72) Inventor: Kanta YAMAMOTO, Kokubunji (JP)

(73) Assignee: Fujitsu Limited, Kawasaki-shi (JP)

(21) Appl. No.: 19/050,190

(22) Filed: Feb. 11, 2025

Related U.S. Application Data
(63) Continuation of application No. PCT/JP2022/039680, filed on Oct. 25, 2022.

(51) Int. Cl. H04L 7/00

(52) U.S. Cl. CPC H04L 7/0012

(57) ABSTRACT

A communication device includes a first port that receives a signal related to a first time source, a second port that receives a signal related to a second time source, a switch that selects the first port or the second port, and processor circuitry configured to execute time synchronization processing by using a signal received via the selected port, detect an event that deteriorates accuracy of the time synchronization processing, transmit information related to a threat to the time synchronization processing to a communication management device when the event is detected, and receive information of recommend port from the communication management device, wherein, when the processor circuitry receives the information from the communication management device, the switch selects the first port or the second port based on a priority of the first time source, a priority of the second time source, and the information received from the communication management device.

### CROSS-REFERENCE TO RELATED APPLICATION

This application is a continuation application of International Application PCT/JP2022/039680 filed on Oct. 25, 2022 and designated the U.S., the entire contents of which are incorporated herein by reference.

### FIELD

The embodiment discussed herein is related to a communication device and a communication management device for radio communication.

### BACKGROUND

A radio communication network includes a plurality of communication devices. For example, a radio access network (RAN) includes a distributed unit (DU) and a radio unit (RU). The DU provides radio link control (RLC), media access control (MAC), a physical layer (PHY)-High function, and the like. For example, the DU processes a signal of an upper layer. The RU provides a PHY-Low function, radio frequency (RF) processing, and the like. Furthermore, the RU may accommodate a radio terminal.

In the radio access network, time synchronization is established between the communication devices in many cases. For example, in an open RAN (O-RAN) architecture defined by an O-RAN alliance, time synchronization is established between an O-RAN DU (O-DU) and an O-RAN RU (O-RU) by using a precision time protocol (PTP).

In the PTP, a synchronization signal is transmitted between a master node and a slave node. In the O-RAN architecture, the O-DU may operate as the master node, and the O-RU may operate as the slave node. Then, the slave node uses the synchronization signal to calculate an offset between a clock of the master node and a clock of the slave node. As a result, the slave node may establish time synchronization with the master node. Note that a method of establishing the time synchronization using the synchronization signal is described in, for example, Japanese Laid-open Patent Publication No. 2022-040947 and Japanese National Publication of International Patent Application No. 2021-507613.

Japanese Laid-open Patent Publication No. 2022-040947, Japanese National Publication of International Patent Application No. 2021-507613, O-RAN.WG4.CUS.0-v09.00, Control, User and Synchronization Plane Specification, O-RAN.SFG.Threat-Model-v03.00 O-RAN Security Threat Modeling and Remediation Analysis, and O-RAN.SFG.Security-Requirements-Specifications-v03.00 O-RAN Security Requirements Specifications are disclosed as related art.

### SUMMARY

According to an aspect of the embodiments, a communication device that is included in a communication system in which between a plurality of time sources and a plurality of nodes that constitutes a radio access network is made redundant and that is mounted in a first node among the plurality of nodes, the communication device includes a first port that receives a signal related to a first time source among the plurality of time sources, a second port that receives a signal related to a second time source among the plurality of time sources, a switch that selects the first port or the second port, and a processor configured to execute time synchronization processing by using a signal received via the port selected by the switch, detect an event that deteriorates accuracy of the time synchronization processing, transmit information related to a threat to the time synchronization processing to a communication management device that manages the plurality of nodes when the event is detected, and receive information to recommend the first port or the second port from the communication management device, wherein, when the processor receives the information to recommend the first port or the second port from the communication management device, the switch selects the first port or the second port based on a priority of the first time source, a priority of the second time source, and the information received from the communication management device.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of a communication system related to an embodiment;

FIG. 2 is a diagram illustrating a configuration of an open radio access network (O-RAN) architecture;

FIGS. 3A and 3B are diagrams (part 1) illustrating a configuration for establishing time synchronization in a fronthaul;

FIGS. 4A and 4B are diagrams (part 2) illustrating the configuration for establishing the time synchronization in the fronthaul;

FIG. 5 is a diagram illustrating an example of the time synchronization using a precision time protocol (PTP);

FIGS. 6A and 6B are diagrams illustrating an example of a configuration for establishing time synchronization in a radio access network using a cloud platform;

FIG. 7 is a diagram illustrating an example of a network system that performs time synchronization in the embodiment;

FIG. 8 is a functional block diagram of a PTP node;

FIG. 9 is a flowchart illustrating an example of a method in which the PTP node notifies a communication management device of a security threat;

FIG. 10 is a functional block diagram of the communication management device;

FIG. 11 is a flowchart related to an example of processing of the communication management device;

FIG. 12 is a flowchart illustrating an example of processing of the PTP node that has received a notification of a recommended port;

FIG. 13 is a diagram illustrating an example of a configuration of a PTP network;

FIG. 14 is a diagram illustrating an example of a method of creating topology information;

FIGS. 15A and 15B are diagrams illustrating an example of the topology information representing the configuration of the PTP network illustrated in FIG. 13;

FIG. 16 is a diagram illustrating an example of an initial state of PTP communication;

FIG. 17 is a diagram illustrating an example of the security threat to the PTP node;

FIG. 18 is a diagram illustrating an example of the topology information updated based on a notification from the PTP node;

FIG. 19 is a diagram illustrating an example of an optimal path calculated by the communication management device; and

FIGS. 20A and 20B are diagrams illustrating an example of hardware configurations of the PTP node and the communication management device.

### DESCRIPTION OF EMBODIMENTS

There are various security threats in the network, and PTP communication for time synchronization may be attacked in the radio access network. For example, when a node that performs the PTP communication is subjected to a denial of service (DOS) attack, processing for the synchronization signal may be delayed. Furthermore, the slave node may not be able to receive the synchronization signal from the master node. Additionally, in these cases, accuracy of the time synchronization is deteriorated.

Here, when the PTP communication is made redundant, each node may select a time source with the best quality from among a plurality of time sources. Note that an existing synchronization method does not have a function of notifying another node that the accuracy of the time synchronization has deteriorated when the accuracy of the time synchronization has deteriorated due to the DOS attack or the like. Therefore, when the accuracy of the time synchronization has deteriorated in the master node, the slave node may not be able to select a time source with high quality. In such a case, since the communication is performed in a state where the accuracy of the time synchronization is low, communication quality or communication efficiency may be deteriorated.

An object related to one aspect of an embodiment is to alleviate an influence of deterioration in accuracy of time synchronization in a radio access network.

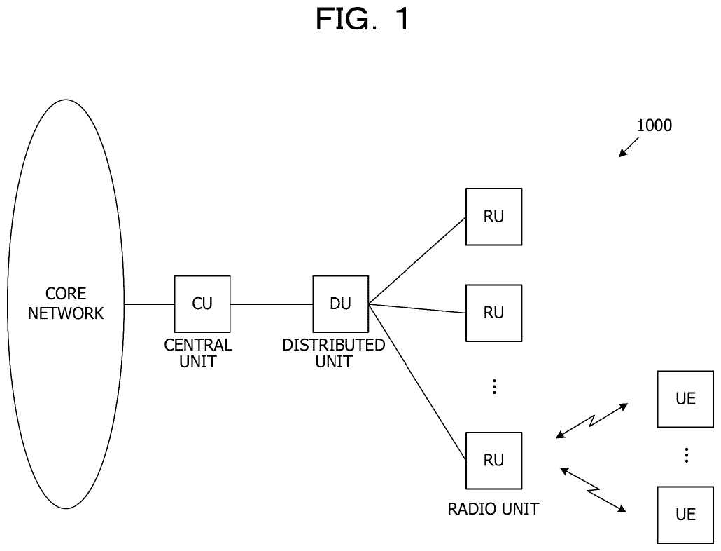

FIG. 1 illustrates an example of a communication system related to an embodiment. In this example, a communication system 1000 includes a central unit (CU), a distributed unit (DU), a radio unit (RU), and a radio terminal. The DU and the RU constitute a radio access network, as described above. For example, the RU may provide a physical layer (PHY)-Low function, radio frequency (RF) processing, and the like, and accommodate the radio terminal. The DU provides radio link control, media access control, a PHY-High function, and the like, and processes a signal of the RU in an upper layer. Note that a plurality of the RUs may be coupled to the DU. For example, the DU may process signals of the plurality of RUs. The CU is provided between a core network and the DU, and processes a signal of the DU in a further upper layer. The radio terminal is not particularly limited, but is, for example, user equipment (UE).

The DU and the RU are mutually coupled by a known interface. For example, the interface between the DU and the RU is a fronthaul interface (or open fronthaul) defined by an open radio access network (O-RAN) alliance.

On the other hand, standardization of an O-RAN architecture that introduces a RAN intelligent controller (RIC) based on a third generation partnership project (3GPP (registered trademark)) specification has been discussed. The RIC is provided outside the CU and/or the DU, and may provide various intelligent determination functions. Additionally, by coupling the RIC and an O-RAN CU (O-CU)/O-RAN DU (O-DU) by a standard interface, an added value service using artificial intelligence (AI)/machine learning (ML) or the like is provided under a multi-vendor environment.

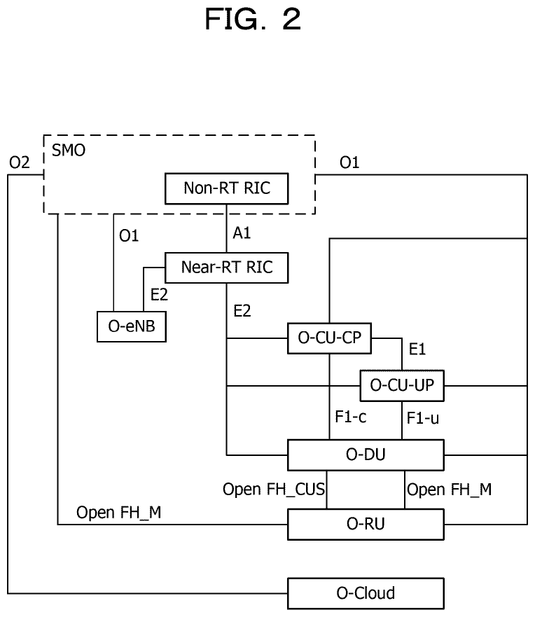

FIG. 2 illustrates a configuration of the O-RAN architecture. In a configuration example illustrated in FIG. 2, the CU includes an O-CU-user plane (UP) and an O-CU-control plane (CP). The O-CU-UP processes a signal of a user plane, and the O-CU-CP processes a signal of a control plane. Note that the O-CU-UP and the O-CU-CP are coupled by an E1 interface. The O-CU-UP and the O-DU are coupled by an F1-u interface, and the O-CU-CP and the O-DU are coupled by an F1-c interface. The O-DU and the O-RU are coupled by an open fronthaul interface.

Service management and orchestration (SMO) is an upper monitoring control system, and manages each device or each function in the O-RAN architecture. The SMO is coupled to the O-CU (the O-CU-UP and the O-CU-CP), the O-DU, and the O-RU via an O1 interface. Furthermore, the SMO may manage an O-eNodeB (O-eNB) which is a fourth generation base station. Moreover, the SMO is also coupled to an O-Cloud via an O2 interface.

The RIC is mounted in the SMO, and provides a service to each device or each function in the O-RAN architecture. Note that, in this configuration example, the RIC mounted in the SMO is a non-real-time RIC (Non-RT RIC) that does not have a high processing cycle. Therefore, a real-time RIC (Near-RT RIC) having a high processing cycle is provided outside the SMO. The non-real-time RIC and the real-time RIC are coupled by an A1 interface. The real-time RIC is coupled to the O-CU (the O-CU-UP and the O-CU-CP) and the O-DU via an E2 interface. Note that, in the following description, the non-real-time RIC and the real-time RIC may be referred to as “RIC” without distinction.

In the open fronthaul interface between the O-DU and the O-RU, a control plane (C-Plane), a user plane (U-Plane), and a synchronization plane (S-Plane) are defined. The control plane is a protocol for transmitting control information. The user plane is a protocol for transmitting user data. The synchronization plane is a protocol for establishing time synchronization, and a precision time protocol (PTP) is used in the O-RAN architecture. Additionally, for example, O-RAN.WG4.CUS.0-v09.00, Control, User and Synchronization Plane Specification proposes a configuration for establishing time synchronization between a time source (primary reference time clock (PRTC)) and an O-DU/O-RU. Note that this configuration is premised on lower layer split (LLS) representing a division method of a communication layer of an open fronthaul.

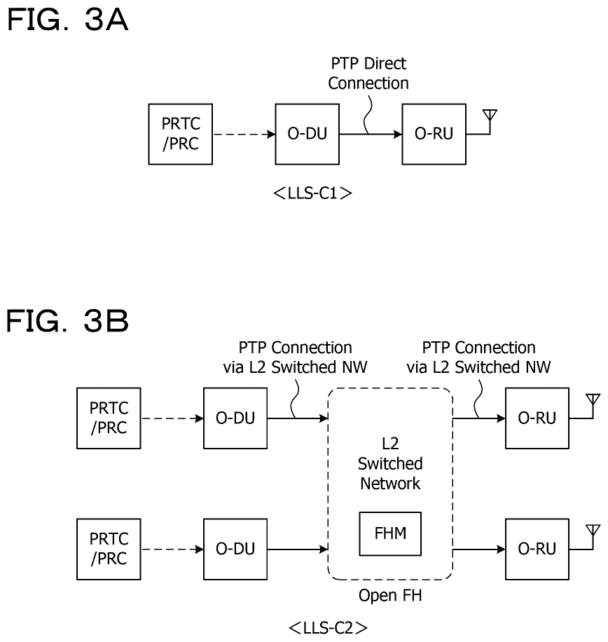

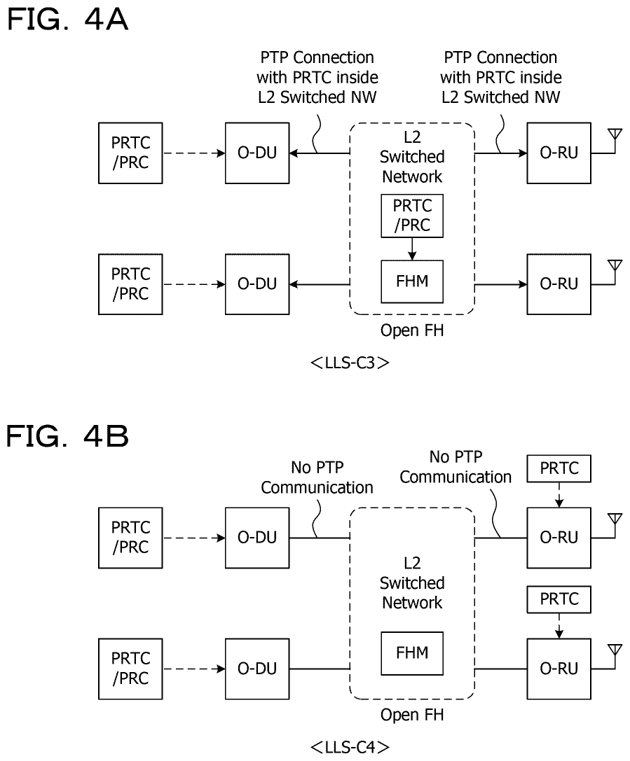

FIGS. 3A to 4B illustrate configurations for establishing time synchronization in the fronthaul. Here, the time synchronization is established using the PTP. Note that the time source PRTC generates a reference clock. It is assumed that accuracy of the reference clock is sufficiently high.

In the configuration (LLS-C1) illustrated in FIG. 3A, the O-DU is synchronized with the time source PRTC. Additionally, PTP communication is directly performed between the O-DU and the O-RU. In this PTP communication, the O-DU operates as the master node, and the O-RU operates as the slave node. For example, the O-RU synchronizes its own local clock with a clock of the O-DU.

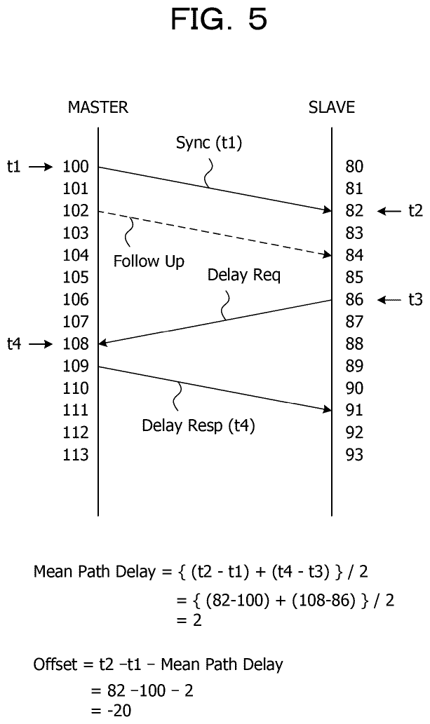

FIG. 5 illustrates an example of the time synchronization using the PTP. Here, each of the master node and the slave node has its own clock. Additionally, by transmitting a PTP message between the master node and the slave node, the slave node synchronizes its own clock with the clock of the master node.

For example, the time synchronization is established by the following procedure. The master node transmits a Sync message to the slave node. The Sync message represents a time (t1) at which the master node transmits the Sync message. The slave node records a time (t2) at which the Sync message arrives at the slave node. Note that, depending on a mode of the PTP, a FollowUp message is transmitted after the Sync message. The slave node transmits a DelayReq message to the master node. At this time, the slave node records a time (t3) at which the DelayReq message is transmitted. When receiving the DelayReq message, the master node transmits a DelayResp message to the slave node. The DelayResp message represents a time (t4) at which the DelayReq message arrives at the master node. Then, based on t1, t2, t3, and t4, the slave node calculates a mean path delay between the master node and the slave node and an offset between the clock of the master node and the clock of the slave node. For example, the mean path delay and the offset are calculated by the following expression.

$$Mean path delay = ( ( t 2 - t 1 ) + ( t 4 - t 3 ) ) / 2$$

$$Offset = t 2 - t 1 - mean path delay$$

In the example illustrated in FIGS. 5, t1, t2, t3, and t4 are 100, 82, 86, and 108, respectively. In this case, the mean path delay is “2”, and the offset is “−20”. Then, the slave node adjusts its own clock based on this offset value. As a result, the clock of the slave node is synchronized with the clock of the master node.

Note that the PTP procedure illustrated in FIG. 5 is executed at, for example, predetermined time intervals. For example, the master node periodically transmits the Sync message. Then, the slave node calculates the mean path delay and the offset described above each time the Sync message is transmitted from the master node. As a result, the accurate time synchronization is always implemented between the master node and the slave node.

In the configurations illustrated in FIGS. 3B, 4A, and 4B, a plurality of the time sources PRTC is provided. Furthermore, between the plurality of time sources PRTCs and the plurality of nodes (O-DU/O-RU) constituting the radio access network is made redundant.

In the configuration (LLS-C2) illustrated in FIG. 3B, each O-DU is synchronized with each corresponding time source PRTC. Furthermore, PTP communication between the O-DU and the O-RU is performed via an L2 switched network. The L2 switched network includes one or a plurality of fronthaul multiplexers FHM. The fronthaul multiplexer FHM is implemented by, for example, an L2 switch device. In PTP communication between the O-DU and the fronthaul multiplexer FHM, the O-DU operates as the master node, and the fronthaul multiplexer FHM operates as the slave node. In PTP communication between the fronthaul multiplexer FHM and the O-RU, the fronthaul multiplexer FHM operates as the master node, and the O-RU operates as the slave node.

In the configuration (LLS-C3) illustrated in FIG. 4A, the time source PRTC is provided in the fronthaul. For example, the fronthaul multiplexer FHM is synchronized with the time source PRTC in the fronthaul. Additionally, in PTP communication between the fronthaul multiplexer FHM and the O-DU, the fronthaul multiplexer FHM operates as the master node, and the O-DU operates as the slave node. Similarly, in PTP communication between the fronthaul multiplexer FHM and the O-RU, the fronthaul multiplexer FHM operates as the master node, and the O-RU operates as the slave node.

In the configuration (LLS-C4) illustrated in FIG. 4B, each O-DU operates in synchronization with the corresponding time source PRTC. Furthermore, each O-RU also operates in synchronization with the corresponding time source PRTC. Therefore, it is not needed to perform PTP communication between the O-DU and the O-RU.

Furthermore, in recent years, virtualization of network devices has been promoted. For example, a configuration for implementing the synchronization plane by mounting a virtualized DU (virtual DU (vDU)) in a cloud platform has been studied.

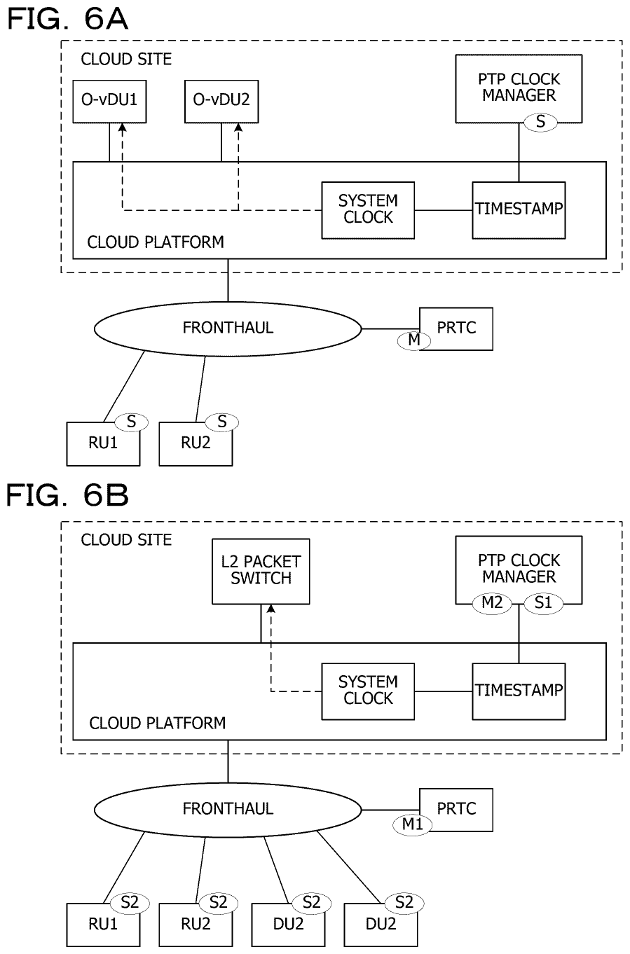

FIGS. 6A and 6B illustrate an example of a configuration for establishing time synchronization in the radio access network using the cloud platform. In the example illustrated in FIGS. 6A and 6B, the synchronization plane is implemented based on the LLS-C3 illustrated in FIG. 4A. Therefore, the time source PRTC is provided in the fronthaul.

In the configuration illustrated in FIG. 6A, a PTP clock manager is mounted in a cloud site. The PTP clock manager operates as the slave node for PTP communication in this configuration. Furthermore, the cloud platform includes a timestamp function and a system clock. Additionally, the PTP clock manager performs the PTP procedure illustrated in FIG. 5 with the time source PRTC to synchronize the system clock with the time source PRTC.

One or a plurality of the virtual DUs (vDUs) is mounted to the cloud platform. Each vDU is implemented by a processor executing a program code describing a function of the O-DU. Note that the vDU may be mounted for each cell, for each slice, or for each vendor. Additionally, the vDU operates using the system clock corrected by the PTP clock manager. As a result, each vDU operates in synchronization with the time source PRTC.

Each RU operates as the slave node for the PTP communication. For example, each RU performs the PTP procedure illustrated in FIG. 5 with the time source PRTC to synchronize its own clock with the time source PRTC.

In the configuration illustrated in FIG. 6B, an L2 packet switch is mounted to the cloud platform. Furthermore, the PTP clock manager relays a PTP packet between the time source PRTC and the DU/RU. For example, the PTP clock manager operates as the slave node with respect to the time source PRTC, and operates as the master node with respect to the DU/RU. For example, the PTP clock manager performs the PTP procedure illustrated in FIG. 5 as the slave node with respect to the time source PRTC to synchronize the system clock with the time source PRTC. Furthermore, the PTP clock manager performs the PTP procedure illustrated in FIG. 5 as the master node with respect to the DU/RU. As a result, the clock of each DU/RU is synchronized with the system clock of the cloud site. As a result, the clock of each DU/RU is synchronized with the time source PRTC.

Meanwhile, in an existing radio access network, a dedicated closed network is configured to cope with a security threat. On the other hand, in the architecture recommended by the O-RAN alliance, secure communication among the O-RU/O-DU/O-CU is implemented by using port-based network access control (IEEE802.1X-2020) without being premised on a dedicated closed network. For example, measure based on zero trust is needed.

In an environment premised on the zero trust, various security threats are concerned even in the PTP communication for establishing time synchronization. For example, O-RAN.SFG.Threat-Model-v03.00 O-RAN Security Threat Modeling and Remediation Analysis studies the following security threats.
(1) Denial of service (DOS) attack on a master clock
(2) Spoofing of the master clock
(3) Illegal PTP instances (Man-in-the-middle)
(4) Interception and deletion of a PTP packet
(5) Packet delay operation

On the other hand, countermeasures against these security threats have been studied. For example, O-RAN.SFG.Security-Requirements-Specifications-v03.00 O-RAN Security Requirements Specifications studies the following items needed for the PTP communication in the O-RAN architecture.
(1) Support multi-PTP domain and provide a plurality of ground masters at the same time
(2) Assign the plurality of ground masters to physically different PTP ports
(3) A PTP communication path supports topology resiliency.
(4) Authentication/authorization of a synchronization plane is implemented with port-based network access control (IEEE802.1X-2020)
(5) Encrypt a PTP message (MACsec)

In this manner, there are various security threats to the synchronization plane of the radio access network, but the countermeasures are prepared against many security threats. Note that, in a case where a DOS attack occurs, the accuracy of the time synchronization may be deteriorated.

For example, in the configuration illustrated in FIG. 6A, in a case where a DoS attack occurs at the cloud site in which the vDU is mounted, it is possible to detect the DoS attack by analyzing a received packet. However, when many resources (such as a processor and a memory) of the cloud site are consumed to detect the DOS attack, resources for executing the PTP procedure may be insufficient. Here, the PTP procedure is periodically executed as described above. Additionally, when the resources for executing the PTP procedure are insufficient, calculation of the mean path delay and the offset may be delayed or may not be performed. Therefore, when the DOS attack occurs, the accuracy of the time synchronization may be deteriorated. This problem is not limited to the configuration illustrated in FIG. 6A, and may occur also in another configuration (for example, the configuration illustrated in FIG. 6B).

Note that even in a case where the DOS attack does not occur, when the resources for executing the PTP procedure are insufficient, calculation of the mean path delay and the offset may be delayed or may not be performed, and the accuracy of time synchronization may be deteriorated. For example, in the configuration illustrated in FIG. 6A or FIG. 6B, the resources may be insufficient in a case where a process operating in the cloud platform becomes out of control or in a case where communication with a large load is executed.

### EMBODIMENT

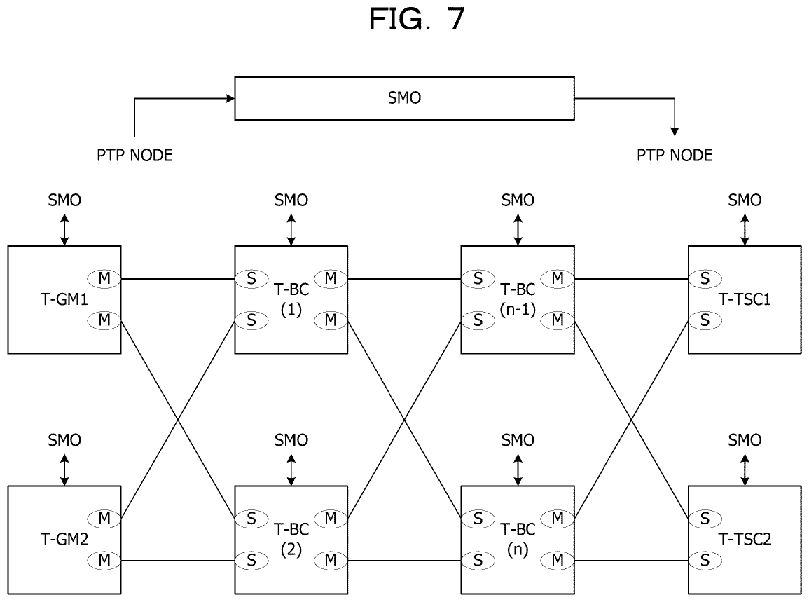

FIG. 7 illustrates an example of a network system that performs time synchronization in the embodiment. In this example, the communication system includes a communication management device SMO and a plurality of PTP nodes. The PTP node has a function of executing the PTP procedure illustrated in FIG. 5 to establish time synchronization. In this example, the PTP node includes the time source PRTC, the O-DU, the fronthaul multiplexer FHM, and the O-RU.

In PTP communication, a telecom grandmaster (T-GM) operates as the time source. A telecom time slave clock (T-TSC) is mounted in a communication device that needs time synchronization (in the radio access network, for example, the O-DU and the O-RU). Furthermore, a plurality of telecom boundary clocks (T-BCs) is provided in the fronthaul. In the example illustrated in FIG. 7, n T-BCs are provided. Additionally, the T-BC relays PTP communication between the T-GM and the T-TSC. The T-BC is mounted to, for example, the fronthaul multiplexer FHM.

The communication system having the configuration described above includes a plurality of the time sources in order to reduce security threats to the time synchronization. In the example illustrated in FIG. 7, two time sources (T-GM1 and T-GM2) are provided. Additionally, PTP communication paths among the time sources and the respective T-TSCs (for example, the O-DU and the O-RU) are made redundant.

For example, a PTP message generated by the time source T-GM1 is transmitted to a T-BC1 and a T-BC2. Furthermore, a PTP message generated by the time source T-GM2 is also transmitted to the T-BC1 and the T-BC2. Note that the PTP message is a message transmitted in the PTP procedure, and includes the Sync message, the FollowUp message, the DelayReq message, and the DelayResp message illustrated in FIG. 5. Furthermore, the PTP message also includes an announcement message for notifying the control information and management information.

Then, the T-BC1 receives the PTP message transmitted from the time source T-GM1 and the PTP message from the time source T-GM2. Here, each PTP node supports a telecom best master clock algorithm (T-BMCA). The T-BMCA is an algorithm for selecting a time source with the best quality from among a plurality of time sources. At this time, the PTP node may select a time source with the best quality based on the announcement message transmitted from each time source (for example, each T-GM). Therefore, the T-BC1 selects a time source with high quality from the time source T-GM1 and the time source T-GM2. Furthermore, the T-BC2 also selects a time source with high quality from the time source T-GM1 and the time source T-GM2. Similarly, each T-BC selects a time source with the best quality.

Each T-TSC receives the PTP messages from the plurality of T-BCs. For example, a T-TSC1 receives the PTP messages from a T-BCn-1 and a T-BCn. Then, the T-TSC1 selects a time source with the best quality based on the received PTP messages. Similarly, a T-TSC2 also selects a time source with the best quality.

Here, the algorithm for selecting a time source with the best quality from among a plurality of time sources (for example, T-BMCA) will be briefly described. In the PTP communication, each time source periodically transmits the announcement message. The announcement message includes the following parameters related to a priority of the time source.
(1) Priority 1 (Optional Value)
(2) Clock Class
(3) Clock Accuracy (Device-Specific Accuracy Index)
(4) Clock Variance (Accuracy of Oscillator)
(5) Priority 2 (Optional Value)

Then, the PTP node select a time source with the best quality by comparing contents of the announcement messages transmitted from the respective time sources. For example, a time source with the highest priority is selected. In a case where the priorities are the same, a time source with the highest priority is selected by comparing other parameters.

Note that, when the priorities of the respective time sources are mutually different, there is a risk that accuracy of the clock may be deteriorated when a failure occurs. Therefore, in many cases, the priorities of the respective time sources are mutually the same.

In a case where the priorities of the respective time sources are mutually the same, the PTP node selects a time source based on, for example, a number of a port that receives the PTP message. For example, in a case where the PTP message transmitted from the time source T-GM1 is received via a port P1 and the PTP message transmitted from the time source T-GM2 is received via a port P2, the PTP node may select a port with the smaller number value. In this case, since the port P1 is selected, this PTP node selects the time source T-GM1. Note that, in a case where the announcement message includes identification information (for example, a media access control (MAC) address) that uniquely identifies the time source, the PTP node may select a time source based on the identification information.

The communication management device SMO manages the devices or the functions in the O-RAN architecture. In the PTP communication, the communication management device SMO manages the communication device mounted in each PTP node.

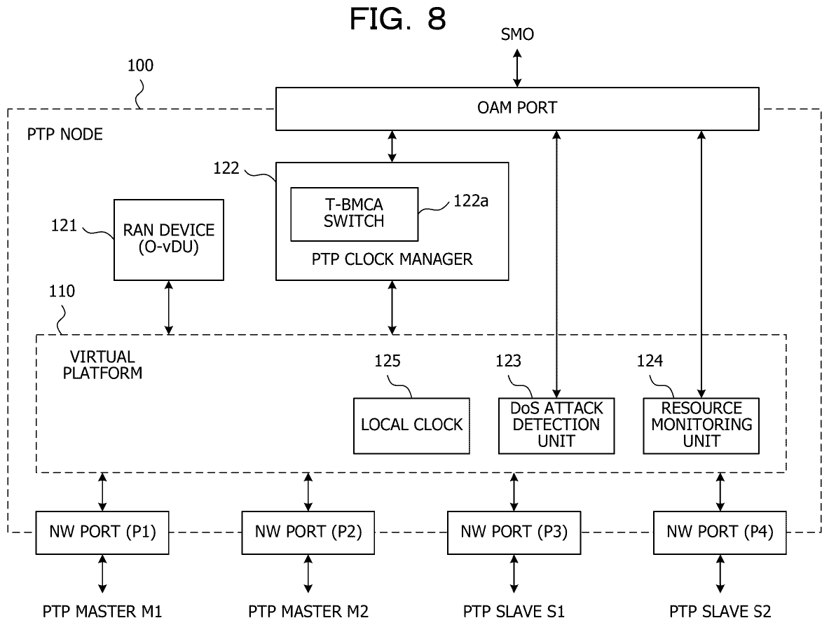

FIG. 8 is a functional block diagram of the PTP node. In this example, a PTP node 100 corresponds to one communication device among the plurality of communication devices constituting the radio access network. For example, the PTP node 100 corresponds to the O-DU, the fronthaul multiplexer FHM, or the O-RU. Furthermore, the PTP node 100 includes a virtual platform 110. The virtual platform 110 is implemented by, for example, hardware including a processor and a memory, and software including an operating system (OS). Additionally, various programs are executed in the virtual platform 110.

The PTP node 100 includes a RAN device 121, a PTP clock manager 122, a DoS attack detection unit 123, a resource monitoring unit 124, a local clock 125, a plurality of NW ports, and an operations, administration and management (OAM) port. Note that the PTP node 100 may include another function or device not illustrated in FIG. 8. Furthermore, a program not illustrated in FIG. 8 may be executed in the virtual platform 110.

The RAN device 121 provides functions of the communication devices constituting the radio access network. In the example illustrated in FIG. 8, the RAN device 121 provides the function of the O-DU. For example, the RAN device 121 operates as an O-vDU.

The PTP clock manager 122 executes the PTP procedure illustrated in FIG. 5 to establish time synchronization. Here, the PTP clock manager 122 may operate as a master of PTP communication, and may also operate as a slave of PTP communication. For example, in a case where the PTP node 100 is the T-BC(1) illustrated in FIG. 7, the PTP clock manager 122 operates as the slave with respect to the T-GM1 and the T-GM2. Furthermore, the PTP clock manager 122 operates as the master with respect to the T-BC(n-1) and the T-BC(n).

The PTP clock manager 122 includes a T-BMCA switch 122a. The T-BMCA switch 122a selects a time source with the best quality from among a plurality of time sources. At this time, the T-BMCA switch 122a selects a time source with the best quality based on, for example, an announcement message transmitted from each of the plurality of time sources. Then, the PTP clock manager 122 executes the time synchronization based on a PTP message from the time source selected by the T-BMCA switch 122a. For example, in a case where the PTP node 100 is the T-BC(1) illustrated in FIG. 7 and the T-BMCA switch 122a selects the time source T-GM1, the PTP clock manager 122 performs the time synchronization based on the PTP message transmitted from the time source T-GM1. Note that, as will be described in detail later, the T-BMCA switch 122a may also select a time source in accordance with an instruction from the communication management device SMO illustrated in FIG. 7.

The DOS attack detection unit 123 detects a DOS attack on the PTP node 100. The DOS attack is detected by, for example, analyzing a header of a received packet. The resource monitoring unit 124 monitors a use rate of resources of the PTP node 100. At this time, the resource monitoring unit 124 may monitor a use rate of a processor and/or a use rate of a memory, mounted to the PTP node 100. Furthermore, the resource monitoring unit 124 may monitor a use rate of the resources assigned to PTP communication. Then, the resource monitoring unit 124 outputs an alarm when the use rate of the resources exceeds a predetermined threshold. The threshold is, for example, a use rate at which a delay is assumed to occur in processing related to the PTP communication, and is determined in advance based on simulation, measurement, or the like.

The local clock 125 generates a clock signal using an oscillator having a predetermined frequency. The clock signal may be a numerical value counted up by one. In this case, the local clock 125 includes a counter.

Note that, in the example illustrated in FIG. 8, the DOS attack detection unit 123, the resource monitoring unit 124, and the local clock 125 are mounted in the virtual platform 110, but the embodiment is not limited to this configuration. For example, the DOS attack detection unit 123 or the resource monitoring unit 124 may be implemented by a software program executed in the virtual platform 110. Furthermore, the local clock 125 may be provided outside the virtual platform 110.

The NW port provides an interface with another PTP node. In this example, the PTP node 100 includes four NW ports P1 to P4. Here, for example, when the PTP node 100 is the T-BC(1) illustrated in FIG. 7, the NW port P1 is coupled to the T-GM1, and the NW port P2 is coupled to the T-GM2. In this case, each of the NW ports P1 and P2 is used as a slave port. The NW port P3 is coupled to the T-BCn-1, and the NW port P4 is coupled to the T-BCn. In this case, each of the NW ports P3 and P4 is used as a master port.

An OAM port provides an interface with the communication management device SMO illustrated in FIG. 2 or FIG. 7. Note that when the DOS attack detection unit 123 detects a DOS attack, the OAM port transmits, to the communication management device SMO, information representing that the PTP node 100 has been subjected to the DOS attack. Furthermore, when the resource monitoring unit 124 outputs an alarm, the OAM port transmits, to the communication management device SMO, information representing that the use rate of the resources of the PTP node 100 exceeds the threshold. Furthermore, the OAM port receives a notification related to setting of the T-BMCA switch 122a from the communication management device SMO.

In this manner, the PTP node 100 has the function of transmitting the information related to the threat to the time synchronization processing to the communication management device SMO, in addition to the function of executing the PTP procedure. Furthermore, the PTP node 100 has the function of receiving the notification related to the setting of the T-BMCA switch 122a from the communication management device SMO. Note that the threat to the time synchronization processing includes the security threat such as the DOS attack and the state where the use rate of the resources exceeds the threshold, but the following mainly describes the security threat.

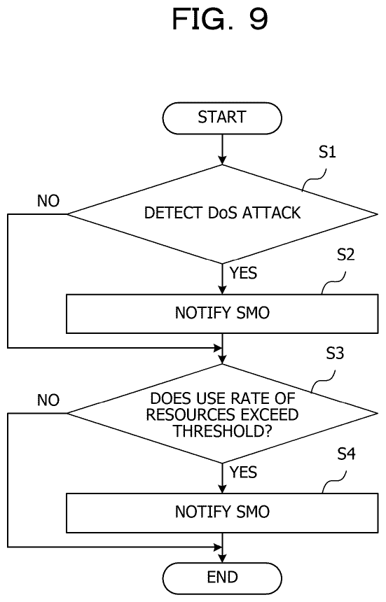

FIG. 9 is a flowchart illustrating an example of a method in which the PTP node 100 notifies the SMO of a security threat. Processing of this flowchart is executed periodically, for example.

In S1, the DOS attack detection unit 123 monitors a DOS attack on the PTP node 100. Then, when the DOS attack is detected, in S2, the DOS attack detection unit 123 notifies the communication management device SMO of PTP threat information (here, information representing detection of the DOS attack) via the OAM port.

In S3, the resource monitoring unit 124 monitors a use rate of the resources of the PTP node 100. Then, when the use rate of the resources exceeds a predetermined threshold, the resource monitoring unit 124 notifies the communication management device SMO of the PTP threat information (here, information representing that the use rate of the resources exceeds the threshold) via the OAM port.

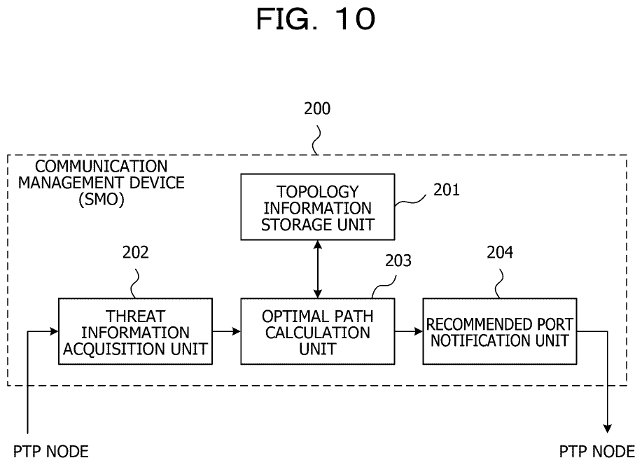

FIG. 10 is a functional block diagram of the communication management device SMO. In this example, a communication management device (SMO) 200 includes a topology information storage unit 201, a threat information acquisition unit 202, an optimal path calculation unit 203, and a recommended port notification unit 204. Note that the communication management device (SMO) 200 may include another function or device not illustrated in FIG. 10.

The topology information storage unit 201 stores topology information representing a topology of a network in which PTP communication is performed. The topology information represents coupling between PTP nodes. For example, the topology information represents coupling between PTP ports.

The threat information acquisition unit 202 collects PTP threat information from each PTP node. The PTP threat information corresponds to the information related to the threat to the time synchronization processing described with reference to FIG. 8 or 9.

The optimal path calculation unit 203 calculates, when the threat information acquisition unit 202 acquires PTP threat information, an optimal path for PTP communication with reference to topology information stored in the topology information storage unit 201. At this time, the optimal path calculation unit 203 calculates an optimal path that does not pass through a PTP node in which a security threat is detected between each T-GM and each T-TSC (O-DU/O-RU). The recommended port notification unit 204 determines, when a new optimal path is calculated, a recommended port for performing PTP communication for each PTP node. Then, the recommended port notification unit 204 notifies corresponding one or a plurality of PTP nodes of the determined recommended port.

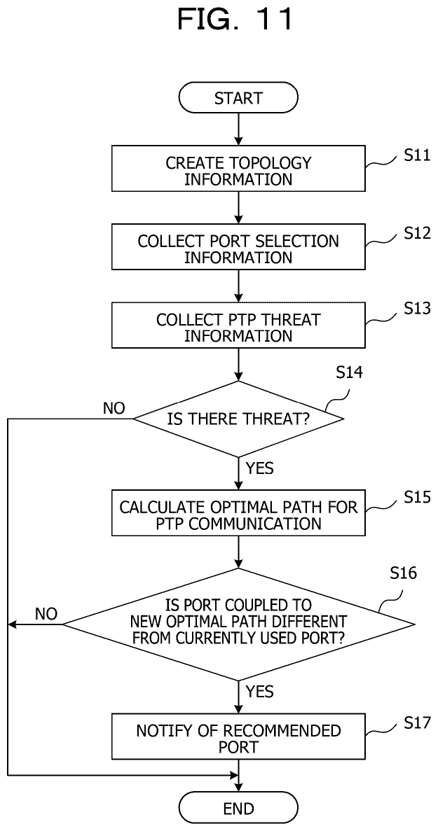

FIG. 11 is a flowchart related to an example of processing of the communication management device (SMO) 200. Note that the flowchart illustrated in FIG. 11 illustrates only processing related to control of PTP communication.

In S11, the communication management device (SMO) 200 collects information representing coupling between nodes from each PTP node 100. Then, the communication management device (SMO) 200 creates topology information based on the collected information. The created topology information is stored in the topology information storage unit 201. Thereafter, processing of S12 to S17 is repeatedly executed at predetermined time intervals.

In S12, the communication management device (SMO) 200 collects port selection information from each PTP node 100. Here, each NW port of the PTP node 100 is associated with a master node. For example, in the example illustrated in FIG. 8, the NW port P1 is associated with a PTP master 1, and the NW port P2 is associated with a PTP master 2.

In S13 and S14, the threat information acquisition unit 202 collects PTP threat information from each PTP node 100. Here, the PTP threat information is transmitted when, for example, a threat to the PTP communication occurs in the PTP node 100. In this example, the PTP threat information is transmitted when a DOS attack is detected and when a use rate of the resources of the PTP node exceeds a threshold.

When the PTP threat information is received (S14: Yes), the optimal path calculation unit 203 calculates an optimal path for the PTP communication in S15. At this time, the optimal path calculation unit 203 calculates, for example, an optimal path that does not pass through the PTP node in which the threat to the PTP communication is detected.

In S16, the recommended port notification unit 204 determines whether or not the newly calculated optimal path is the same as a current path. Then, when the newly calculated optimal path is different from the current path, the recommended port notification unit 204 determines, for each PTP node, whether or not a port coupled to the new optimal path is the same as a port currently used. Then, when the port coupled to the new optimal path is different from the currently used port, the recommended port notification unit 204 determines the port coupled to the new optimal path as a “recommended port” in S17. The recommended port represents a port that is preferably used to perform the PTP communication. Then, the recommended port notification unit 204 notifies the corresponding PTP node of the determined port. The PTP node 100 that has received the notification of the recommended port determines whether or not to switch the PTP port.

Note that the recommended port notification unit 204 may determine, for each PTP node, whether or not a time source coupled to the new optimal path is the same as a time source currently used. In this case, when the time source coupled to the new optimal path is different from the time source currently used, the recommended port notification unit 204 may determine the time source coupled to the new optimal path as a recommended time source. Then, the recommended port notification unit 204 notifies the corresponding PTP node of the new time source.

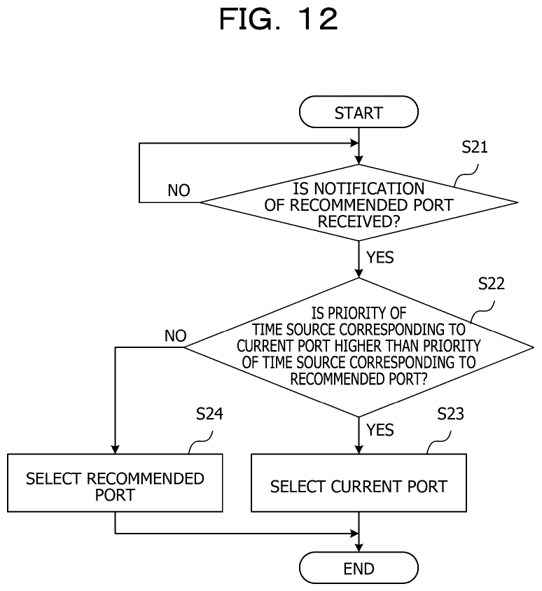

FIG. 12 is a flowchart illustrating an example of processing of the PTP node 100 that has received the notification of the recommended port. Note that, before receiving the notification of the recommended port, the PTP node 100 determines a port that receives a PTP message based on an announcement message transmitted from each time source (for example, the T-GM). Here, each NW port of the PTP node 100 is associated with a predetermined master node. For example, before receiving the notification of the recommended port, each time source to be used by each PTP node 100 is set based on the announcement message.

In S21, the PTP clock manager 122 stands by for the notification of the recommended port transmitted from the communication management device (SMO) 200. During a period of the standby for the notification of the recommended port, the PTP clock manager 122 selects a port for performing the PTP communication based on the PTP message transmitted from each time source (T-GM). For example, the PTP clock manager 122 performs time synchronization using the PTP message received via the selected port.

When receiving the notification of the recommended port from the communication management device (SMO) 200, the PTP clock manager 122 compares a priority of a time source corresponding to the current port with a priority of a time source corresponding to the recommended port in S22. Then, when the priority of the time source corresponding to the current port is higher than the priority of the time source corresponding to the recommended port, the PTP clock manager 122 selects the current port in S23. On the other hand, when the priority of the time source corresponding to the current port is not higher than the priority of the time source corresponding to the recommended port, the PTP clock manager 122 selects the recommended port in S24. Therefore, when the priority of the time source corresponding to the current port and the priority of the time source corresponding to the recommended port are mutually the same, the recommended port is selected.

### EXAMPLE

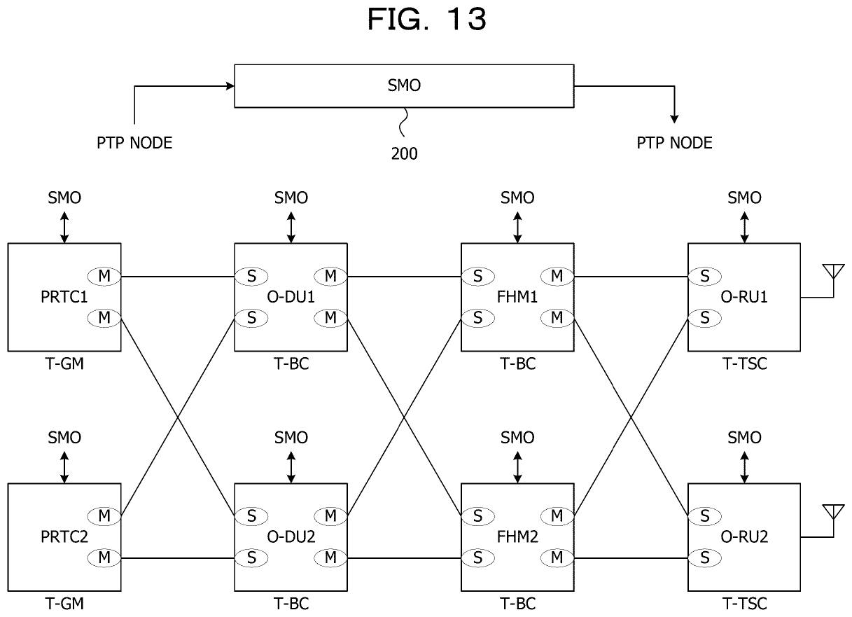

FIG. 13 illustrates an example of a configuration of the PTP network. In this example, the PTP network includes two time sources (PRTC1 and PRTC2), two O-DUs (O-DU1 and O-DU2), two fronthaul multiplexers (FHM1 and FHM2), and two O-RUs (O-RU1 and O-RU2). Each time source PRTC, each O-DU, each fronthaul multiplexer FHM, and each O-RU are implemented by the PTP node 100. Furthermore, each time source PRTC corresponds to the T-GM, each O-DU and each fronthaul multiplexer FHM correspond to the T-BCs, and each O-RU corresponds to the T-TSC.

In FIG. 13, “M” represents a master port of PTP communication, and “S” represents a slave node of the PTP communication. Additionally, the PTP procedure illustrated in FIG. 5 is executed in an interface coupling the master port M and the slave port S. Furthermore, each of the respective O-DUs, the respective fronthaul multiplexers FHM, and the respective O-RUs corresponds to the PTP node 100 illustrated in FIG. 8, and includes the T-BMCA switch 122a.

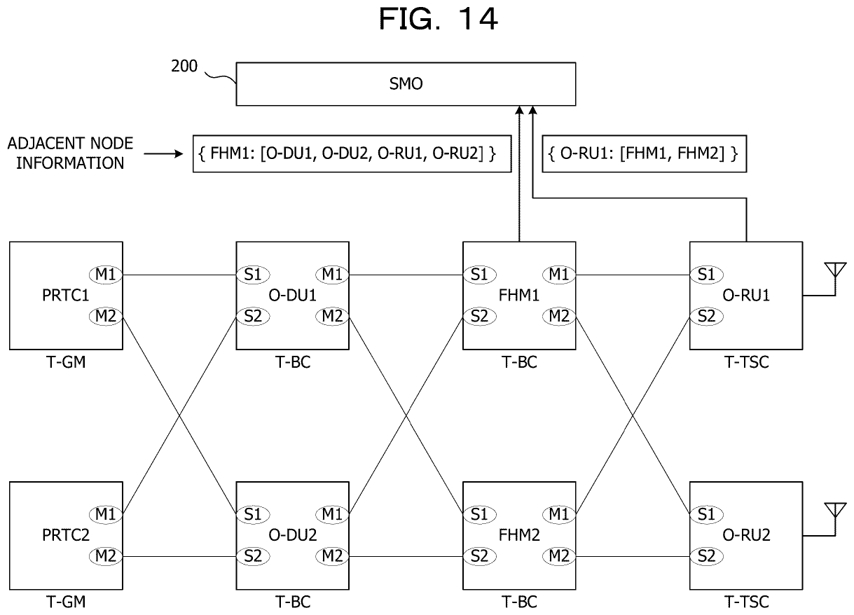

FIG. 14 illustrates an example of a method of creating the topology information. In this example, each PTP node recognizes a PTP node adjacent to itself by negotiation, message exchange, or the like executed at the time of startup. Then, each PTP node transmits adjacent node information representing the PTP node adjacent to itself to the communication management device (SMO) 200. In the example illustrated in FIG. 14, the adjacent node information is transmitted from the fronthaul multiplexer FHM1 and the O-RU1, but the adjacent node information is actually transmitted from all the PTP nodes. Then, the communication management device (SMO) 200 creates the topology information based on the adjacent node information received from each PTP node.

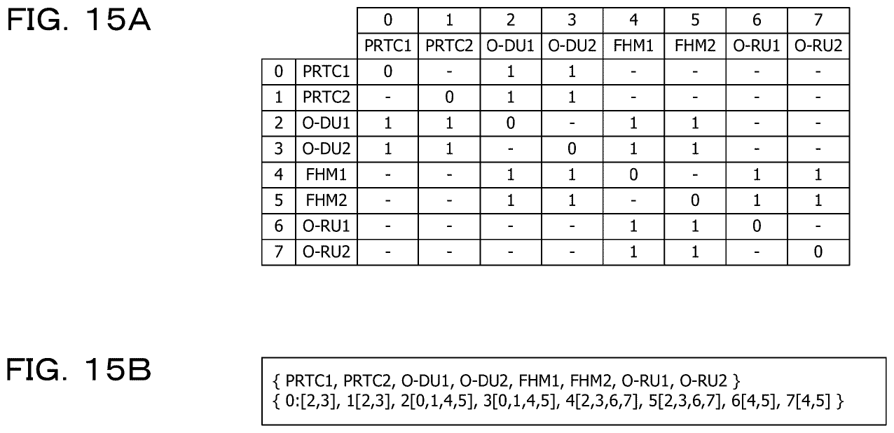

FIGS. 15A and 15B illustrate an example of the topology information representing the configuration of the PTP network illustrated in FIG. 13. The topology information represents another adjacent PTP node for each PTP node. Note that FIG. 15A illustrates the topology information represented in a matrix format, and FIG. 15B illustrates the topology information represented in a list format, but content is mutually the same.

In an adjacent matrix illustrated in FIG. 15A, “1” represents an adjacent state, and “-” represents a non-adjacent state. For example, in the PTP network illustrated in FIG. 13, PTP nodes adjacent to the time source PRTC1 are the O-DU1 and the O-DU2. Therefore, in a record corresponding to the time source PRTC1 of the adjacent matrix, “1” is set to each of the O-DU1 and the O-DU2. Furthermore, PTP nodes adjacent to the O-DU1 are the time source PRTC1, the time source PRTC2, the fronthaul multiplexer FHM1, and the fronthaul multiplexer FHM2. Therefore, in a record corresponding to the O-DU1 of the adjacent matrix, “1” is set to each of the PRTC1, the PRTC2, the FHM1, and the FHM2.

Note that, although not particularly limited, the topology information in the matrix format illustrated in FIG. 15A is stored in the topology information storage unit 201. Furthermore, in the interface between the PTP node and the communication management device (SMO) 200, the topology information in the list format illustrated in FIG. 15B is transmitted.

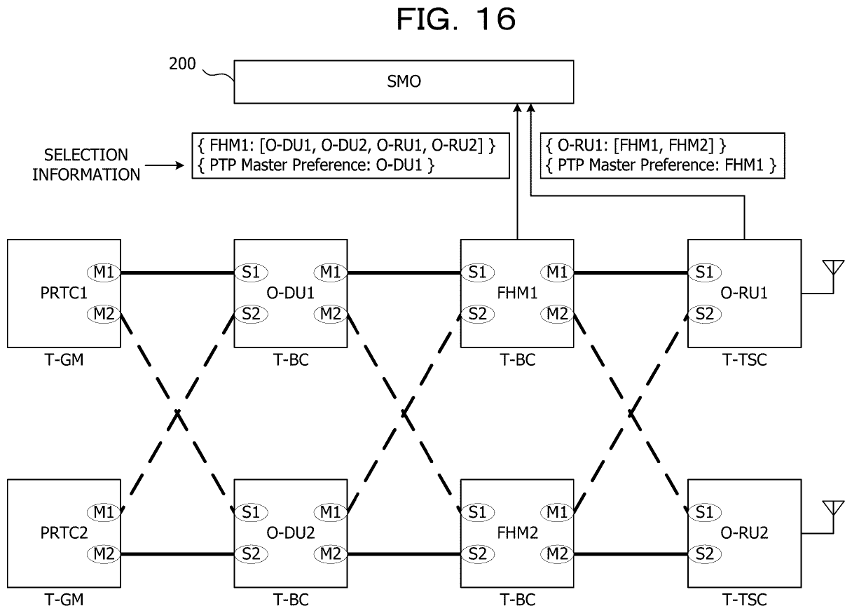

FIG. 16 illustrates an example of an initial state of the PTP communication. Note that, in FIG. 16, an elliptical shape drawn in each PTP node corresponds to the NW port illustrated in FIG. 8. Each of M1 and M2 represents a master ports, and each of S1 and S2 represents a slave port. Furthermore, in FIG. 16, a path coupled to a port selected by a slave node is represented by a thick solid line. Furthermore, a path coupled to a port not selected by the slave node is represented by a thick broken line.

For example, a master port M1 of the time source PRTC1 is coupled to a slave port S1 of the O-DU1, a master port M2 of the time source PRTC1 is coupled to a slave port S1 of the O-DU2, a master port M1 of the time source PRTC2 is coupled to a slave port S2 of the O-DU1, and a master port M2 of the time source PRTC2 is coupled to a slave port S2 of the O-DU2. Additionally, in the initial state, the O-DU1 selects the slave port S1, and the O-DU2 selects the slave port S2. For example, the O-DU1 selects the time source PRTC1, and the O-DU2 selects the time source PRTC2.

Note that, as described above, each PTP node selects a port for the PTP communication based on a parameter related to a priority described by an announcement message transmitted from each time source PRTC. Note that, in a case where the priorities of the respective time sources PRTC are mutually the same, the PTP node selects the time source PRTC based on, for example, a number of the port.

Furthermore, each PTP node transmits selection information representing a selected master node to the communication management device (SMO) 200. In the example illustrated in FIG. 16, selection information transmitted from the fronthaul multiplexer FHM1 represents that the O-DU1 is selected as the master node. Furthermore, selection information transmitted from the O-RU1 represents that the FHM1 is selected as the master node. Therefore, the communication management device (SMO) 200 may recognize which master node is selected by each PTP node.

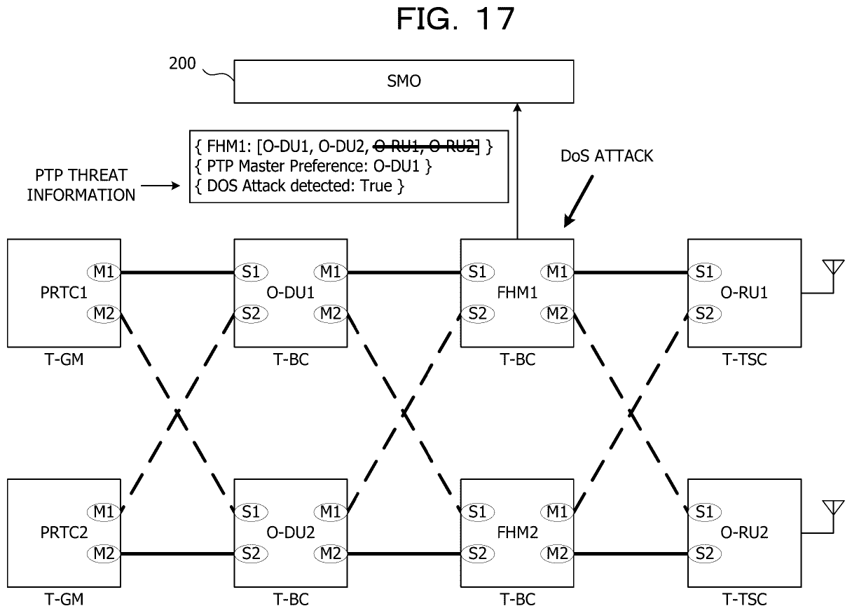

FIG. 17 illustrates an example of a security threat to the PTP node. In this example, a DOS attack occurs on the fronthaul multiplexer FHM1, which is one of the PTP nodes. In this case, the DOS attack detection unit 123 of the fronthaul multiplexer FHM1 detects the DOS attack. Then, the DOS attack detection unit 123 transmits the PTP threat information representing that the fronthaul multiplexer FHM1 has been subjected to the DOS attack to the communication management device (SMO) 200 via the OAM port. In this example, the PTP threat information is represented by “DOS Attack detected: True”. Furthermore, since the fronthaul multiplexer FHM1 has been subjected to the DOS attack, the PTP nodes coupled to a downstream side of the fronthaul multiplexer FHM1 are deleted in the adjacent node information.

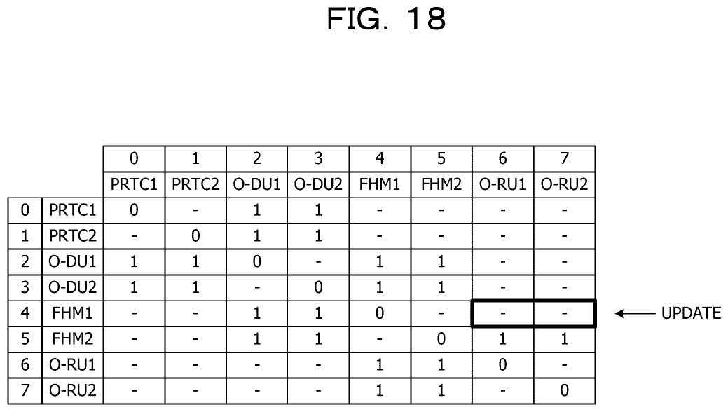

When receiving the adjacent node information illustrated in FIG. 17, the communication management device (SMO) 200 updates the topology information. In this example, the topology information is updated as illustrated in FIG. 18. For example, in a record corresponding to the fronthaul multiplexer FHM1, the PTP nodes (for example, the O-RU1 and the O-RU2) coupled to the downstream side of the fronthaul multiplexer FHM1 are deleted.

Furthermore, when receiving the PTP threat information illustrated in FIG. 17, the communication management device (SMO) 200 calculates an optimal path for the PTP communication in S11 illustrated in FIG. 11. At this time, the optimal path calculation unit 203 calculates an optimal path between each of the time sources (the PRTC1 and the PRTC2) and the T-TSCs (the O-RU1 and the O-RU2) so as not to pass through the fronthaul multiplexer FHM1 that is a transmission source of the PTP threat information. For example, since the fronthaul multiplexer FHM1 has been subjected to the DOS attack, an optimal circuit that does not use paths between the fronthaul multiplexer FHM1 and the PTP node coupled to the downstream side thereof is calculated. For example, an optimal path is calculated in a configuration in which it is assumed that there are no path between the fronthaul multiplexer FHM1 and the O-RU1 and no path between the fronthaul multiplexer FHM1 and the O-RU2.

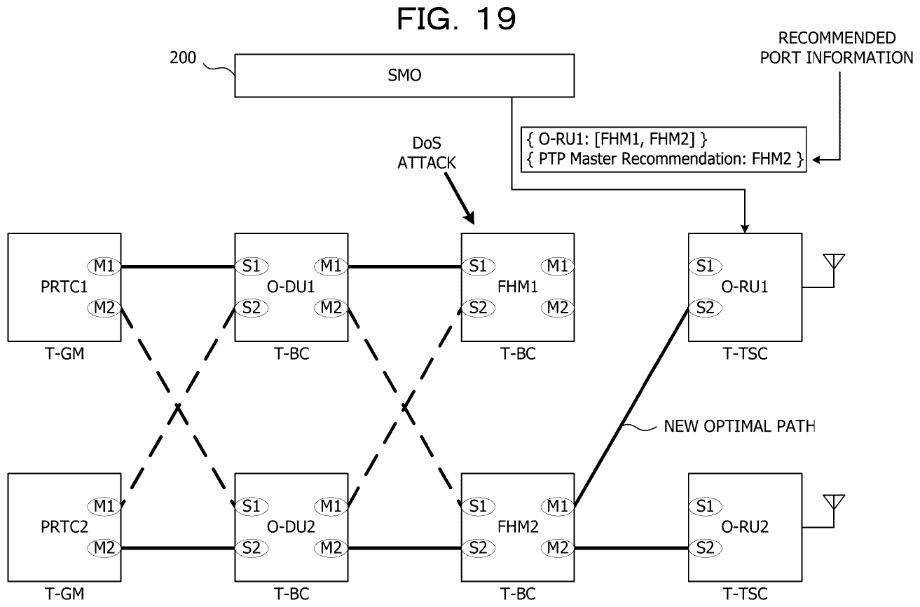

As a result, it is assumed that an optimal path illustrated in FIG. 19 is obtained. For example, the optimal path between the time sources (the PRTC1 and the PRTC2) and the O-RU1 is a path from the time source PRTC2 to the O-RU1 via the O-DU2 and the fronthaul multiplexer FHM2. For example, in a case where the PTP communication is performed via the newly calculated optimal path, the O-RU1 transmits and receives a PTP message by using a slave port S2. On the other hand, the O-RU1 currently transmits and receives the PTP message by using a slave port S1. Therefore, the communication management device (SMO) 200 determines that it is preferable to perform the port switching in S16 of FIG. 11. Then, the recommended port notification unit 204 transmits recommended port information recommending use of the slave port S2 to the O-RU1. In the example illustrated in FIG. 19, the recommended port information is represented by “PTP Master Recommendation: FHM2”.

When receiving the recommended port information, the O-RU1 executes the processing of S22 to S24 illustrated in FIG. 12. At this time, when a priority of the time source (for example, the PRTC1) corresponding to the currently used port S1 is higher than a priority of the time source (for example, the PRTC2) corresponding to the recommended port S2, the PTP clock manager 122 continuously selects the current port. For example, as illustrated in FIG. 17, the O-RU1 performs PTP communication with the fronthaul multiplexer FHM1. Here, the fronthaul multiplexer FHM1 performs PTP communication with the O-DU1, and the O-DU1 performs PTP communication with the time source PRTC1. Therefore, the O-RU1 performs time synchronization based on the time source PRTC1. For example, the time source used by the O-RU1 does not change. In this case, the security threat has occurred in the path of the PTP communication, but the time source with the high priority is continuously used.

On the other hand, when the priority of the time source (for example, the PRTC1) corresponding to the currently used port S1 is not higher than the priority of the time source (for example, the PRTC2) corresponding to the recommended port S2, the PTP clock manager 122 selects the recommended port. For example, when the priority of the time source PRTC1 and the priority of the PRTC2 are mutually the same, the PTP clock manager 122 selects the recommended port notified from the communication management device (SMO) 200. For example, as illustrated in FIG. 19, the O-RU1 performs PTP communication with the fronthaul multiplexer FHM2. Here, the fronthaul multiplexer FHM2 performs PTP communication with the O-DU2, and the O-DU2 performs PTP communication with the time source PRTC2. Therefore, the O-RU1 performs time synchronization based on the time source PRTC2. For example, the time source used by the O-RU1 is changed from the PRTC1 to the PRTC2. In this case, since the priorities of the two time sources are the same, the time source coupled to the PTP communication path in which no security threat has occurred is selected.

In this manner, when detecting an event that deteriorates the accuracy of the time synchronization, the PTP node related to the embodiment notifies the communication management device (SMO) 200 of the detection result. Then, the communication management device (SMO) 200 determines a recommended port to be used for PTP communication and notifies one or a plurality of PTP nodes of the recommended port. Therefore, deterioration in the accuracy of the time synchronization in each PTP node is suppressed.

### <Hardware Configuration>

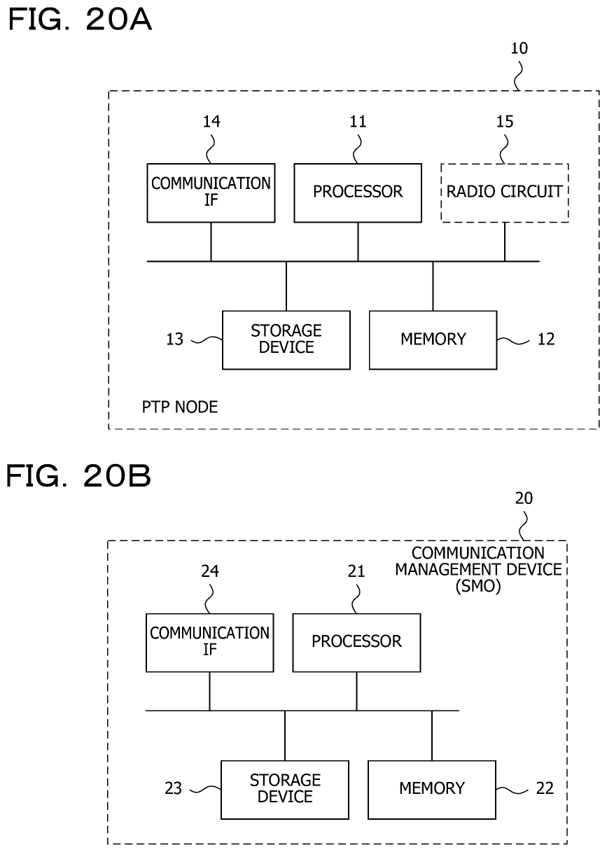

FIG. 20A illustrates an example of a hardware configuration of the PTP node. Here, a PTP node 10 corresponds to the PTP node 100 illustrated in FIG. 8, and includes a processor 11, a memory 12, a storage device 13, and a communication interface circuit 14. Furthermore, when the PTP node is the O-RU, the PTP node 10 further includes a radio circuit 15.

The processor 11 controls an operation of the PTP node 10 by executing a communication program stored in the storage device 13. The communication program includes a program code describing a procedure for PTP communication. Therefore, the processor 11 may execute this communication program to provide the functions of the PTP clock manager 122, the DOS attack detection unit 123, and the resource monitoring unit 124. The memory 12 is used as a work area for the processor 11. The storage device 13 stores the communication program described above and another program. The communication interface circuit 14 includes the NW ports and the OAM port illustrated in FIG. 8, and communicates with another PTP node and the communication management device (SMO) 200. The radio circuit 15 includes a radio transmitter that transmits a signal to the radio terminal and a radio receiver that receives a signal from the radio terminal.

FIG. 20B illustrates an example of a hardware configuration of the communication management device (SMO). Here, a communication management device (SMO) 20 corresponds to the communication management device (SMO) 200 illustrated in FIG. 10, and includes a processor 21, a memory 22, a storage device 23, and a communication interface circuit 24. For example, a configuration of the communication management device (SMO) 20 is substantially the same as that of the PTP node 10. Note that a communication program executed by the processor 21 includes a program code describing the procedure of the flowchart illustrated in FIG. 11. Therefore, the processor 21 executes this communication program to provide the functions of the threat information acquisition unit 202, the optimal path calculation unit 203, and the recommended port notification unit 204.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A communication device that is included in a communication system in which between a plurality of time sources and a plurality of nodes that constitutes a radio access network is made redundant and that is mounted in a first node among the plurality of nodes, the communication device comprising:
a first port that receives a signal related to a first time source among the plurality of time sources;
a second port that receives a signal related to a second time source among the plurality of time sources;
a switch that selects the first port or the second port; and
processor circuitry configured to
execute time synchronization processing by using a signal received via the port selected by the switch,
detect an event that deteriorates accuracy of the time synchronization processing,
transmit information related to a threat to the time synchronization processing to a communication management device that manages the plurality of nodes when the event is detected, and
receive information to recommend the first port or the second port from the communication management device,
wherein, when the processor circuitry receives the information to recommend the first port or the second port from the communication management device, the switch selects the first port or the second port based on a priority of the first time source, a priority of the second time source, and the information received from the communication management device.

2. The communication device according to claim 1, wherein,
when the processor circuitry is in execution of the time synchronization processing by using a signal received via the first port, the processor circuitry receives information to recommend the second port, and when the priority of the second time source is not higher than the priority of the first time source, the switch selects the second port.

3. The communication device according to claim 1, wherein
the processor circuitry detects an attack on the communication device, and
the processor circuitry transmits the information related to the threat when the processor circuitry detects the attack on the communication management device.

4. The communication device according to claim 3, wherein
the processor circuitry detects a denial of service (DOS) attack on the communication device.

5. The communication device according to claim 1, wherein
the processor circuitry monitors a use rate of resources of the communication device, and transmits the information related to the threat to the communication management device when the use rate exceeds a predetermined threshold.

6. A communication management device that is included in a communication system in which between a plurality of time sources and a plurality of communication devices that constitutes a radio access network is made redundant and each of the plurality of communication devices performs time synchronization processing by using signals transmitted from the plurality of time sources, and that manages the plurality of communication devices, the communication management device comprising:
a storage that stores topology information that represents coupling between the plurality of time sources and the plurality of communication devices; and
processor circuitry configured to
acquire information related to a threat to the time synchronization processing from a first communication device among the plurality of communication devices,
calculate, for each of the plurality of communication devices, a communication path to receive a signal transmitted from any one of the plurality of time sources so as not to pass through the first communication device, by using the topology information, and
determine, for each of the plurality of communication devices, a recommended port to receive a signal transmitted from any one of the plurality of time sources based on the calculated communication path, and notify a corresponding communication device of information that represents the determined recommended port.

7. A communication system comprising:
a plurality of time sources;
a plurality of communication devices that constitutes a radio access network; and
a communication management device that manages the plurality of communication devices,
wherein communication paths between the plurality of time sources and the plurality of communication devices are made redundant,
each of the plurality of communication devices includes:
a first port that receives a signal related to a first time source among the plurality of time sources;
a second port that receives a signal related to a second time source among the plurality of time sources;
a switch that selects the first port or the second port; and
first processor circuitry configured to
execute time synchronization processing by using a signal received via the port selected by the switch,
detect an event that deteriorates accuracy of the time synchronization processing,
transmit information related to a threat to the time synchronization processing to the communication management device when the event is detected, and
receive information to recommend the first port or the second port from the communication management device,
the communication management device includes:
a storage that stores topology information that represents coupling between the plurality of time sources and the plurality of communication devices; and
second processor circuitry configured to
acquire the information related to the threat from a first communication device among the plurality of communication devices,
calculate, for each of the plurality of communication devices, a communication path to receive a signal transmitted from any one of the plurality of time sources so as not to pass through the first communication device, by using the topology information, and
determine, for each of the plurality of communication devices, a recommended port to receive a signal transmitted from any one of the plurality of time sources based on the calculated communication path, and notify a corresponding communication device of information that represents the determined recommended port, and
in a second communication device among the plurality of communication devices, when processor circuitry receives the information to recommend the first port or the second port from the communication management device, the switch selects the first port or the second port based on a priority of the first time source, a priority of the second time source, and the information received from the communication management device.
